(19) United States
(12) Patent Application Publication
(10) Pub. No.: US 2025/0348594 A1
(43) Pub. Date: Nov. 13, 2025

(54) PREDICTING LIKELY-VULNERABLE CODE CHANGES USING MACHINE LEARNING

(71) Applicant: Google LLC, Mountain View, CA (US)

(72) Inventor: Keun Soo Yim, San Jose, CA (US)

(21) Appl. No.: 19/204,144

(22) Filed: May 9, 2025

Related U.S. Application Data
(60) Provisional application No. 63/645,801, filed on May 10, 2024.

(51) Int. Cl. G06F 21/57; G06F 8/71

(52) U.S. Cl. CPC G06F 21/577; G06F 8/71; G06F 2221/033

(57) ABSTRACT

Methods, systems, and apparatus, including computer programs encoded on a computer storage medium, for analyzing computer software source code. One of the methods includes receiving an updated snapshot of a source code file that comprises a change to an existing snapshot of the source code file maintained at a code repository for a software project; obtaining feature data; processing the feature data using a machine learning model to generate a classification output that classifies the updated snapshot into one of a plurality of categories; and performing, based on the classification output, an action with respect to the updated snapshot.

### CROSS-REFERENCE TO RELATED APPLICATIONS

This application claims priority to U.S. Provisional Application No. 63/645,801, filed on May 10, 2024. The disclosure of the prior application is considered part of and is incorporated by reference in its entirety in the disclosure of this application.

### BACKGROUND

This specification relates to analyzing computer software source code.

Source code is typically maintained by developers in a code repository using a version control engine. Version control engines generally maintain multiple revisions of the source code in the code repository, each revision being referred to as a snapshot. Each snapshot includes the source code of files of the code base as the files existed at a particular point in time. The code repository can store source code for one or more software projects.

Snapshots stored in a version control system can be generated when developers send commits to the code base. A commit includes a snapshot as well as other pertinent information about the snapshot, e.g., the developer of the snapshot and data about ancestor commits.

### SUMMARY

This specification generally describes a source code management system that receives and analyzes a snapshot of a source code file and that automatically determines one or more actions to perform with respect to the snapshot based on the analysis, e.g., to incorporate the snapshot into the source code file, to request a security review of the snapshot, to block the snapshot from being incorporated into the source code file, and so forth. The source code management system can be implemented as computer programs on one or more computers in one or more locations.

The subject matter described in this specification can be implemented in particular embodiments so as to realize one or more of the following advantages.

By leveraging machine learning and a curated set of features that include one or more of (1) code review features, (2) process tracking features, and (3) text mining features, to automatically and more accurately classify an updated snapshot of a source code file into a set of categories including (1) vulnerability inducing, (2) vulnerability fixing, and (3) likely normal, the techniques described in this specification can conserve considerable processing and memory resources that would otherwise be allocated to dealing with false positive vulnerability detections. The more accurate source code vulnerability detection results can be used to improve software development lifecycle. For example, the number of vulnerabilities that are introduced into a software project as a result of source code submission can be lowered, while the number of vulnerabilities that are removed prior to any submission can be increased.

By achieving a lower false positive ratio, e.g., lower than 2%, with respect to vulnerability inducing snapshot detection, the techniques described in this specification can provide enhanced security by enabling resources to be directed towards addressing/resolving actual security vulnerabilities, rather than being expending on investigating false positives. Further, by resolving actual security vulnerabilities, the techniques may prevent viruses and malware from infecting an organization's computer system. Given that organizations are typically only able to direct a finite amount of resources towards application security, focusing those resources on actual security vulnerabilities rather than false positives means that actual vulnerabilities may be resolved sooner than would otherwise be the case, thereby reducing the likelihood that the vulnerability is identified and used by viruses/malware to gain access to the computer system.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example source code management system and an example training system.

FIG. 2 is an example illustration of a vulnerability prevention (VP) framework implemented by a source code review system.

FIG. 3 is an example illustration of operations performed by a training system to train a classifer model.

FIG. 4 is a flow diagram of an example process for performing an action with respect to an updated snapshot.

Like reference numbers and designations in the various drawings indicate like elements.

### DETAILED DESCRIPTION

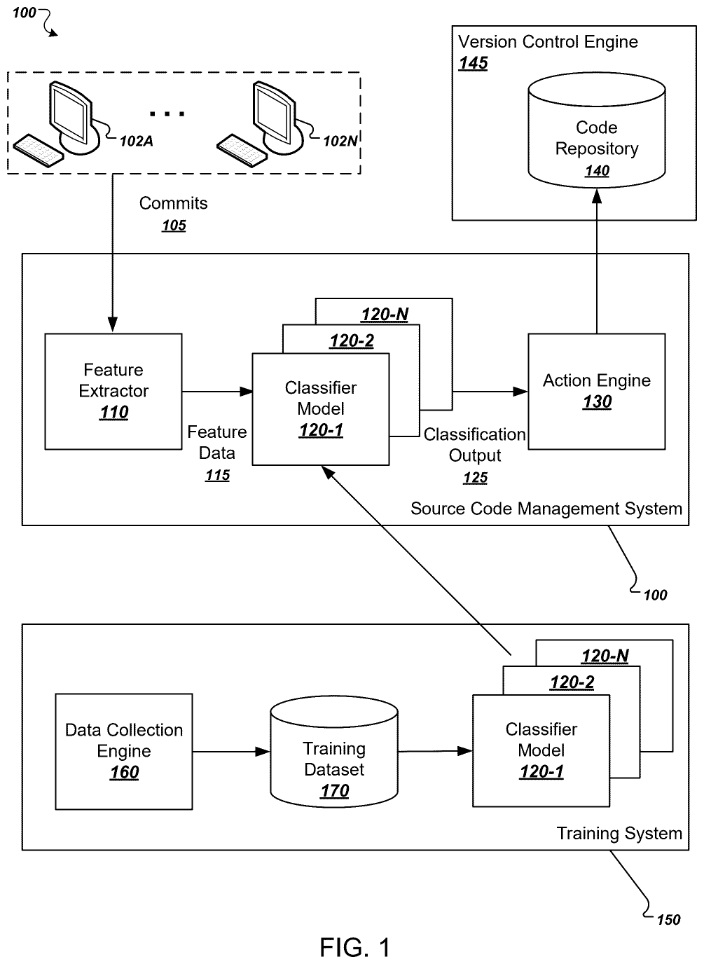

FIG. 1 shows an example source code management system 100 and an example training system 150. The source code management system 100 and the training system 150 are examples of a system implemented as computer programs on one or more computers in one or more locations, in which the systems, components, and techniques described below can be implemented.

The source code management system 100 is in communication with a plurality of developer devices 102A-N over a data communication network, such as a local area network (LAN), a wide area network (WAN), the Internet, a mobile network, or a combination thereof.

Each developer device 102A-N can be associated with a respective developer, e.g., developer device 102A is associated with developer A, and developer device 102N is associated with developer N. A developer may either be an individual, or alternatively be an entity, e.g., developers on a team, developers within a department of an organization, or some other identifiable group of developers of software.

Each developer device 102 can be any type of computing device. Example developer devices 102 include personal computers, e.g., desktop, laptop, and tablet computers, gaming devices, mobile communication devices, e.g., smart phones, digital assistant devices, augmented reality devices, virtual reality devices, and other devices that can communicate with the source code management system 100 over the data communication network.

Each developer device 102A-N includes a coding tool. Example coding tools include any appropriate application that facilitates edit, generation, or both of a subset of source code files that can be submitted to the source code management system 100. The application can be a dedicated coding tool or a light-weight client, e.g., a web browser.

For example, the coding tool can be an integrated development environment (IDE). An IDE can include an application, or a suite of applications, that facilitates developing source code on the user device 102 through a graphical user interface. An IDE often has applications including a source code editor, a compiler, and a debugger. IDEs often also have a file browser as well as object and class browsers.

A developer can use the coding tool installed on the developer device to send commits 105 through the source code management system 100 to a version control engine 145 maintaining a code repository 140 storing one or more software projects. Examples of version control engines include Subversion, GIT, ClearCase, and Perforce, to name just a few.

Despite being illustrated as separate from each other in FIG. 1, in some implementations, the source code management system 100 includes the version control engine 145. The source code management system 100 can be configured to interact with many developers, e.g., thousands or millions of developers, and each developer can send commits 105 to the version control engine 145.

The version control engine 145 can be configured to perform functions related to maintaining revisions of the software projects stored in the code repository 140, e.g., receiving commits 105 from developer devices 102A-N, maintaining a log of commits to the software project, modifying the source code files of the software project according to a received commit, maintaining information related to the commit and the developer of the commit, and so on.

The code repository 140 includes a collection of source code files of each software project. The code repository 140 generally includes the collection of source code files organized in a particular way, e.g., arranged in a hierarchical directory structure, with each source code file of the software project having a respective path.

In this specification, source code files include files of any type that contain statements intended to be interpreted by a processor of a data processing apparatus, whether directly or through compilation or interpretation, including source code, configuration files, build files, and other non-binary, text files.

In some cases, the software projects stored in the code repository 140 can include a large software project, such as an enterprise software project or a major open-source project, that involve the activity of many developers. Examples of enterprise software projects include inventory management systems, project and resource management systems, big data analysis systems, large-scale network-delivered services, operational systems for major engineering products, to name just a few. Examples of major open-source projects include free and open-source software (FOSS) projects, e.g., an Android Open-source Project (AOSP).

Each commit 105 includes an updated snapshot of a source code file stored in the code repository 140 for the software project a developer is working on, as well as information about that developer and metadata for the updated snapshot. The updated snapshot includes a change to an existing snapshot of the source code file stored in the code repository 140 for the software project.

The source code management system 100 implements a vulnerability prevention (V P) framework that achieves early detection of cybersecurity vulnerabilities contained in the commits 105 received from the plurality of developers. A cybersecurity vulnerability in source code is a weakness or flaw within the source code that could be exploited by malicious attackers to gain unauthorized access, disrupt operations, or steal sensitive information.

In some cases, the VP framework implemented by the source code management system 100 detects a cybersecurity vulnerability contained in an updated snapshot of a source code file included in a commit 105 even before the commit 105 is sent to the version control engine 145 by a developer contributing to the software project.

For example, the VP framework can detect a cybersecurity vulnerability at pre-submit time, i.e., while the developer is working on an updated snapshot of a source code file, before the commit 105 that includes the updated snapshot is sent to the version control engine 145, and hence before the change included in the updated snapshot is incorporated into the source code file stored in the code repository 140 for the software project.

Early detection of cybersecurity vulnerabilities during software development is crucial for improving security and reducing development costs. By identifying vulnerabilities early, developers can address them before they become costly to fix or exploited by attackers. In addition, the early detection of the cybersecurity vulnerabilities reduces the computing resources and time needed to remedy the problems that may be caused by any cybersecurity vulnerabilities contained in the source code.

Early detection of cybersecurity vulnerabilities is particularly advantageous in major open-source projects. For example, free and open-source software (FOSS) supply chains for the Internet-of-Things devices (e.g., mobile phones, wearable devices, smart televisions, and other smart home devices such as smart doorbells, smart locks, smart thermostats) present an attractive target for malicious attackers (e.g., supply chain attackers), e.g., because developers of FOSS projects can send commits that include seemingly innocuous code changes that nonetheless contain vulnerabilities without revealing their identities and motives. The cybersecurity vulnerabilities contained in the snapshots may then propagate quickly and quietly to the end-user devices.

In the case of major open-source projects, the overall security testing cost will be minimized by identifying such cybersecurity vulnerabilities early at pre-submit time, before the snapshots are submitted to upstream, open-source project repositories. Otherwise, the security testing burden is multiplied across all the downstream software projects that depend on any of the upstream projects.

To implement the VP framework, the source code management platform 100 includes a feature extractor 110, a plurality of classifier models 120-1-120-N, and an action engine 130.

The feature extractor 110 is configured to obtain feature data 115 associated with each commit 105. To do this, the feature extractor 110 can extract features 115 from data obtained from any of a variety of sources that is made available to the feature extractor 110 by performing any of a variety of data processing operations, e.g., semantic analysis and text mining operations, on the obtained data.

For example, the feature extractor 110 can obtain features from a coding tool, e.g., an integrated development environment (IDE), included in each of the plurality of developer device 102A-N, which provides data that includes code editing history (in some cases up to the level of single keystrokes) and the current source code files. As another example, the feature extractor 110 can obtain features from the version control engine 145, which provides data that includes code revision history and the previous source code files.

Example of the feature data 115 that can be obtained by the feature extractor 110 will now be discussed.

In an example, the feature data can include human profile (HP) features. The HP features represent information about the affiliations of a developer and/or reviewer of an updated snapshot. Examples of HP features include a HPₐᵤₜₕₒᵣ feature and a HP_{reviewer} feature.

HPₐᵤₜₕₒᵣ feature represents the trustworthiness of the email domain of a developer. Email domains of the developer can be ranked on a predetermined scale, e.g., an integer scale that starts with 1 for the most trustworthy domain type and increases by 1 as the trustworthiness declines. For example, in Android Open-source Project (AOSP), information about the email domains of the developers that indicate the organizations to which the developers belong are available. In this example, the value of ‘1’ indicates that a developer email domain is affiliated with the primary sponsor of A OSP (i.e., Google); ‘2’ indicates that the developer email domain is affiliated with AOSP (i.e., Android); ‘3’ indicates that the developer email domain is affiliated with an Android partner organization; ‘4’ indicates that the developer email domain is affiliated with other relevant open-source communities; and ‘5’ indicates that the developer email domain is one of other domains.

HP_{reviewer} feature represents the trustworthiness of the email domain of a reviewer. Email domains of the reviewer can be ranked on a predetermined scale similar to that of the HPₐᵤₜₕₒᵣ features. For example, for an updated snapshot, HP_{reviewer} feature is determined for each of a plurality of reviewers, and then the largest value among the HP_{reviewer} features determined for the plurality of reviewers is used as HP_{reviewer} feature (i.e., the reviewer having an email domain that is affiliated with the most external organization).

In another example, the feature data can include change complexity (CC) features. The CC features represent the complexity of the updated snapshot. The greater the complexity, the greater the likelihood of errors, flaws, failures, faults, bugs, or weaknesses in the updated snapshot. Examples of HP features include a C_{Cada} feature and a C_{Cdel} feature.

C_{Cada} feature represents a count of the total number of code lines added by an updated snapshot to the existing snapshot, e.g., a count of the total number of code lines added by the source code file included in the updated snapshot.

C_{Cdel} feature represents a count of the total number of code lines deleted by an updated snapshot from the existing snapshot, e.g., a count of the total number of code lines deleted by the non-binary, text files included in the updated snapshot, such as source code, configuration files, and build files.

In another example, the feature data can include patch set complexity (PC) features. An updated snapshot may have multiple patch sets if it undergoes multiple revisions (e.g., one patch set in response to each code review). The PC features represent the volume of those patch sets. Examples of PC features include a PC_{count} feature, a PCᵣₑᵥᵢₛᵢₒₙ feature, a PC_{relative_revision} feature, a PC_{avg_patchset} feature, a PC_{max_patchset} feature, and PC_{min_patchset} feature.

PC_{count} feature represents a count of the total number of patch sets uploaded by a developer before an updated snapshot is finally submitted to the version control engine 145. For example, each patch set may be generated as a result of a reviewing process.

PCᵣₑᵥᵢₛᵢₒₙ feature represents a count of the total number of code lines added or deleted by each of the multiple patch sets of an updated snapshot. For example, the count of the total number of code lines added or deleted by each patch set can be determined by calculating the difference between a consecutive pair of patch sets. In some implementations, the multiple patch sets exclude the first patch set, and PCᵣₑᵥᵢₛᵢₒₙ feature thus represents the volume of revisions made after the first patch set.

PC_{relative_revision} feature represents the amount of all revision activities relative to the complexity of the final patch set. In some implementations, PC_{relative_revision} feature is calculated as a ratio between PCᵣₑᵥᵢₛᵢₒₙ and a count of the total number of code lines added or deleted by the final patch set.

PC_{avg_patchset} feature represents the average volume of edits (i.e., a count of the total number of added or deleted code lines) across all patch sets of an updated snapshot. In some implementations, PC_{avg_patchset} feature can be calculated by PCᵣₑᵥᵢₛᵢₒₙ/(PC_{count}-1).

PC_{max_patchset} feature and PC_{min_patchset} feature represent the largest and smallest patch set complexity, respectively, where the complexity is measured by the count of the total number of added or deleted code lines within a patch set of an updated snapshot.

In another example, the feature data can include review pattern (RP) features. The RP features characterize the interactions between the developer of the updated snapshot and one or more reviewers of the updated snapshot, such as patterns in code review discussions.

Hence the RP features may also be referred to as code review features. Examples of RP features include a RPₜᵢₘₑ feature, a RP_{weekday} feature, a RPₕₒᵤᵣ feature, and a RP₊₂ feature.

RPₜᵢₘₑ feature represents a length of time elapsed, e.g., in hours, minutes, or seconds, between the initial creation of an updated snapshot and a final submission of the updated snapshot.

RP_{weekday} feature indicates the day of week when an updated snapshot is submitted. In some implementations, RP_{weekday} feature is represented using an integer value (e.g., 1 for Sunday, 2 for Monday, and so on).

RPₕₒᵤᵣ feature indicates the hour of day when an updated snapshot is submitted. In some implementations, RPₕₒᵤᵣ feature is represented using a 24-hour format (e.g., 0 for [midnight, lam), 1 for [lam, 2 am), and so on).

RP₊₂ feature indicates how an updated snapshot is approved prior being submitted, e.g., represents whether the updated snapshot is self-approved by the developer. Self-approval occurs when the developer gives a ‘+2’ review score, while no other reviewer gives a positive score (′+1′ or ‘+2’). In some implementations, RP₊₂ feature is represented using a Boolean value (e.g., 0 for self-approval, and 1 for not self-approval)

In another example, the feature data can include human history (HH) features. The HH features represent the creditability of the individuals behind every patch set of an updated snapshot. Examples of HH features include a HH_{developer} feature, a HH_{reviewer} feature, a HH_{min_reviewer} feature, and a HH_{avg_reviewer} feature.

Updated snapshot that has been submitted in the past can be classified into a plurality of categories that include a likely normal change (LNC) category and a vulnerability inducing change (ViC) category. In some cases, for each historically submitted updated snapshot that is classified into the likely normal change (LNC) category, the developer gets 2 points and every reviewer giving a review score of ‘+1’ or ‘+2’ gets 1 point; for each updated snapshot that is classified into the vulnerability inducing change (ViC) category, the developer gets-3 points and a reviewer giving a positive review score gets-2 points. These scores for historically submitted updated snapshot can then be aggregated for each developer or reviewer when determining these HH features.

HH_{developer} feature represents the human history score of a developer of an updated snapshot. In some implementations, HH_{developer} feature is calculated as a ratio between the ViC score of the author and the LNC score of the same author.

HH_{reviewer} feature represents the human history score of the reviewer(s) of an updated snapshot. Similar to the HH_{developer} feature, in some implementations, the HH_{reviewer} feature of a reviewer is calculated as a ratio between the ViC score and the LNC score of the reviewer. For an updated snapshot with more than one reviewer, the highest ratio among all reviewers can be used as the HH_{reviewer} feature.

HH_{min_reviewer} feature and HH_{avg_reviewer} feature represent the minimum and average, respectively, of the human history scores of all reviewers of an updated snapshot.

In another example, the feature data can include vulnerability history (V H) features. The VH features characterize, e.g., the temporal locality, spatial locality, and churn locality aspects of, the vulnerabilities that have occurred in the historically submitted updated snapshots. Examples of VH features include a VH_{temporal_max} feature, a VH_{temporal_min} feature, a VH_{temporal_avg} feature, a VH_{spatial_max} feature, a VH_{spatial_min} feature, and a VH_{spatial_avg} feature.

As discussed above, updated snapshot that has been submitted in the past can be classified into a plurality of categories that include a likely normal change (LNC) category and a vulnerability inducing change (ViC) category. In some implementations, for a source code file maintained at the code repository for the software project, the vulnerability history score of the source code file is calculated by (the number of updated snapshots that include the source code file that have been classified into the likely normal change (LNC) category) −3×(the number of updated snapshots that include the source code file that have been classified into the vulnerability inducing change (ViC) category). Thus, any source code file involved in an updated snapshot classified into the likely normal change (LNC) category gets −3 points, while any source code file involved in an updated snapshot classified into the vulnerability inducing change (ViC) category gets+1 point.

VH_{temporal_max} feature and VH_{temporal_min} feature represent the maximum and minimum score, respectively, vulnerability history scores among the vulnerability history scores of all source code files included in an updated snapshot.

VH_{temporal_avg} feature represents the average score among the vulnerability history scores of all source code files included in an updated snapshot. VH_{temporal_avg} feature thus reflects the churn locality, since code changes involving many source code files often have relatively simple modifications per file.

VH_{spatial_max} feature, VH_{spatial_min} feature, and VH_{spatial_avg} features represent the spatial locality in the vulnerability history patterns. These features are determined based on the number of (1) the files in the same directory as ones in an updated snapshot, and (2) the files with the same file names (e.g., using different extensions) across all directories in the updated snapshot that have been classified into the vulnerability inducing change (ViC) category. The updated snapshot gets −2 points for every such a file. Similarly, the updated snapshot gets +1 point for every file in the same directory that has been classified into the likely normal change (LNC) category.

In another example, the feature data can include process tracking (PT) features. The PT features characterize historical changes to the source code file, e.g., represent patterns in the volume of code changes throughout a software development lifecycle. The patterns include the trends in the numbers of updated snapshots that have been classified into the vulnerability inducing change (ViC) category, the vulnerability fixing change (VfC) category, and the likely normal change (LNC) category. For example, a mature software project might see fewer updated snapshots overall, even fewer updated snapshots classified into the vulnerability inducing change (ViC) category, and a relatively increase in the number of updated snapshots classified into the vulnerability fixing change (VfC) category. Examples of VH features include a PT_{change_volume} feature, a PT_{vfc_volume} feature, and a PT_{vic_volume} feature. In some implementations, the VH features are pre-computed for each source code file of each software project maintained in the code repository 140.

PT_{change_volume} feature represents the change in code volume (i.e., the change in the number of code lines) between the current time period (e.g., a current week, month, or quarter) and the previous time period (e.g., a previous week, month, or quarter).

PT_{vfc_volume} feature represents the change in the number of updated snapshots classified into the vulnerability fixing change (V fC) category that have been submitted between the current time period and the previous time period.

PT_{vic_volume} feature represents the change in the number of updated snapshots classified into the vulnerability inducing change (ViC) category that have been submitted between the current time period and the previous time period.

In another example, the feature data can include text mining (TM) features. TM features characterize semantic similarities between source code elements extracted by parsing the updated snapshot and a predetermined set of source code elements. In some implementations, the predetermined set of source code elements include code symbols that are specific to one or more target programming languages, e.g., Java, JavaScript, Python, C/C++, C#, SQL, HTML, and so on.

Examples of code symbols include: arithmetic operators (e.g., +, −, *,/, %), comparison operators (e.g., ==, !=, & &), conditional operators (e.g., if, else, switch), loop operators (e.g., for, while), assignment operators (e.g., =, <<=, +=), logical operators (e.g., &, [\hat{ }, ˜), memory access operators (e.g., −>,.), among others.

Examples of TM features include a TM_{arithmetic} feature, a TM comparison feature, a TM_{conditional} feature, a TMₗₒₒₚ feature, a TM_{assignment} feature, a TM_{logical} feature, and a TM_{memory_access} feature.

TM_{arithmetic} feature represents a ratio between (i) a number of the arithmetic operators that have been extracted from the updated snapshot and (ii) a total number of all of the code symbols that have been extracted from the updated snapshot. Other example TM features, such as a TM conditional feature, a TMₗₒₒₚ feature, a TM_{assignment} feature, a TM_{logical} feature, and a TM feature can be defined similarly to TM_{arithmetic} feature.

For each commit 105, the source code management platform 100 uses each of one or more of the plurality of classifier models 120-1-120-N to process the feature data 115 obtained by the feature extractor 110 to generate a classification output 125 for the commit 105 that classifies the updated snapshot included in the commit 105 into one of a plurality of categories.

In some implementations, the plurality of categories include: a vulnerability inducing change (ViC) category, a vulnerability fixing change (V fC) category, and a likely normal change (LNC) category. The vulnerability inducing change (ViC) category indicates that an updated snapshot contains a cybersecurity vulnerability, i.e., it adds a new cybersecurity vulnerability to the existing snapshot. The vulnerability fixing change (VfC) category indicates that an updated snapshot alleviates, e.g., fixes or repairs, an existing cybersecurity vulnerability of the existing snapshot. The likely normal change (LNC) category indicates that an updated snapshot is unlikely to contain a cybersecurity vulnerability, i.e., it is unlikely to add a new cybersecurity vulnerability to the existing snapshot.

In these implementations, for example, the classification output can include a respective score, e.g., probability score, corresponding to each of the plurality of categories, each score representing a likelihood that the updated snapshot belongs to the corresponding category.

Alternatively, in some other implementations, the plurality of categories include: a likely vulnerable change category and a likely normal change category. The likely vulnerable change category indicates that an updated snapshot is likely to contain a cybersecurity vulnerability. The likely normal change category indicates that an updated snapshot is unlikely to contain a cybersecurity vulnerability. In these implementations, for example, the classification output can be a binary output, where ‘1’ indicates the likely vulnerable change category and ‘0’ indicates the likely normal change category.

Each of the plurality of classifier models 120-1-120-N can be configured as any of a variety of machine learning models. For example, each of the plurality of classifiers 120-1-120-N can be configured as one of: a decision tree model (such as a decision tree model generated using Quinlan's C4.5 algorithm, described in R. Quinlan, C4.5: Programs for Machine Learning, M organ Kaufmann Publishers, San Mateo, CA), a random forest model, a support vector machine (SV M) model, a logistic regression mode, a naïve Bayes model, or a neural network model (e.g., a feedforward neural network such as a fully connected neural network or an attention neural network, or a recurrent neural network such as a long short-term memory (LSTM) neural network or a Gated Recurrent Unit (GRU) neural network).

To generate the classification output 125, in some implementations, different ones of the plurality of classifiers 120-1-120-N process different feature data 115, e.g., different subsets of the example features mentioned above, whereas, in other implementations, different ones of the plurality of classifiers 120-1-120-N process the same feature data 115, e.g., all of the example features mentioned above, or the same subset of the example features mentioned above.

After having used each of one or more of the plurality of classifier models 120-1-120-N to generate a classification output 125 for the commit 105, the action engine 130 is configured to automatically determine one or more actions to perform with respect to the updated snapshot included in the commit 105 based on the one or more classification outputs, e.g., to incorporate the updated snapshot into the source code file maintained in the code repository 140, to request a security review of the updated snapshot prior to incorporating the updated snapshot into the source code file maintained in the code repository 140, to block the updated snapshot from being incorporated into the source code file maintained in the code repository 140, and so forth.

The training system 150 operates to implement an iterative training process to train each of the plurality of classifier models 120-1-120-N on a training dataset 170 over multiple training iterations. In particular, the training system 150 train each classifier model 120-1-120-N to determine trained values of the parameters of the classifier model that will enable the classifier model to accurately classify updated snapshots.

The training dataset 170 includes a plurality of training inputs. Each training input includes features associated a source code snippet that represents a source code change. Each training input is associated with a target output that represents a corresponding ground truth category of the source code snippet included in the training input.

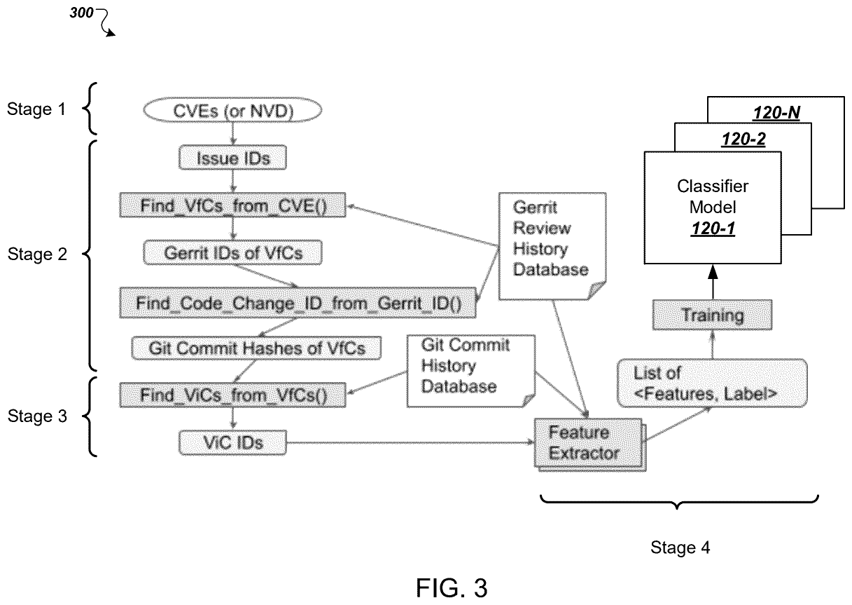

The training system 150 includes a training data generation engine 160 that implements a training data generation process, as discussed below with reference to FIG. 3, to generate the training inputs and their corresponding target outputs for inclusion in the training dataset 170 based on one or more security databases.

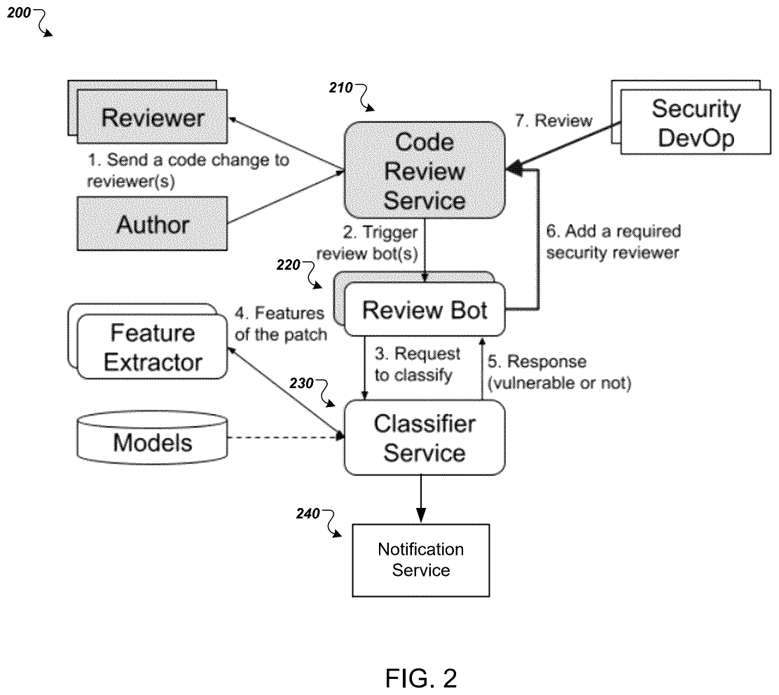

FIG. 2 is an example illustration 200 of a vulnerability prevention (VP) framework that can be implemented by the source code review system 100 of FIG. 1.

The VP framework includes a code review service 210. A developer initiates the code review service 210 by uploading an updated snapshot of a source code file to the source code review system 100. The code review service 210 allows the developer to assign reviewers for the updated snapshot (step 1). The code review service 210 automatically triggers a review bot (step 2) in response to the request of a developer or reviewer, or when the updated snapshot satisfies predefined triggering conditions.

The VP framework includes a review bot 220. The review bot 220, once triggered, gathers data associated with the updated snapshot, including the specific edits made by the updated snapshot, along with associated metadata of the updated snapshot and the baseline source code file. In some implementations, the review bot 220 additionally obtains data generated as a result of compilation, analysis, and testing of the updated snapshot against the baseline source code file. The review bot 220 then forwards the data associated with the updated snapshot to a classifier service (step 3).

The VP framework includes a classifier service 230. When the classifier service 230 is triggered, it utilizes the feature extractor 110 to extract feature data 115 of the updated snapshot from the data provided by the review bot 220 (step 4). Subsequently, the classifier service 230 uses each of one or more of the plurality of classifier models 120-1-120-N to process the feature data 115 to generate a classification output for the commit 105 that classifies the updated snapshot into one of the plurality of categories (step 5). The VP framework determines, based on the classification output(s), whether additional security review or security testing should be requested for the updated snapshot.

The VP framework includes a notification service 240. When the updated snapshot is classified by the classifier service 230 into a certain category, e.g., a vulnerability inducing change (ViC) category or a likely vulnerable change category, the notification service 240 automatically generates a notification to the code review service 210, e.g., by posting a comment on the updated snapshot in the code review service 210. The notification (e.g., comment) alerts the developer of the updated snapshot and existing reviewers to the potential presence of security vulnerabilities. Optionally, the VP framework further assigns one or more additional reviewers (step 6), e.g., one or more additional security domain experts, to conduct an additional security review of the updated snapshot (step 7).

The VP framework is thus applicable to a variety of use cases. Each use case involves performing one or more actions with respect to an updated snapshot by the source code management system 100. A few examples are discussed below.

In an example, the VP framework is applicable to pre-submit security review. Pre-submit security review utilizes the VP framework to assess an updated snapshot to be sent to the version control engine 145 to determine whether to request a security review of the updated snapshot, e.g., by security domain experts, prior to sending the updated snapshot to the version control engine 145 where it will be incorporated into the source code file maintained in the code repository 140.

In another example, the VP framework is applicable to pre-submit security testing. Pre-submit security testing utilizes the VP framework to assess an updated snapshot to be sent to the version control engine 145 to determine whether to request extra security testing of the updated snapshot, e.g., static analysis, dynamic analysis, or fuzzing, prior to sending the updated snapshot to the version control engine 145 where it will be incorporated into the source code file maintained in the code repository 140.

In another example, the V P framework is applicable to post-submit security review. Post-submit security review utilizes the VP framework to assess all updated snapshots that have been sent to the version control engine 145 and incorporated into the code repository 140 within a predetermined time period (e.g., within a day, week, or month) to identify a set of updated snapshots and to request additional, in-depth secure code inspection by security domain experts of the updated snapshots in the identified set.

In another example, the VP framework is applicable to selective, pre-submit security testing. Selective, pre-submit security testing patches the updated snapshot into baseline code, builds artifacts (e.g., binaries), and executes relevant security tests against the built artifacts. Selective, pre-submit security testing supports customization of security test configurations, including parameter tuning to target specific functions and adjust the maximum testing time.

To facilitate selective, pre-submit security testing, the review bot 220 can be extended to generate tailored testing parameters, e.g., by leveraging the source code delta of the updated snapshot, the vulnerability statistics of a software project, or both. The resulting data-driven method allows the extended review bot 220 to use either the default parameter values or dynamically generate new ones, helping to optimize the balance between the security testing coverage and associated costs.

In another example, the V P framework is applicable to a post-submit use case. Post-submit time use case involves implementing a replay mechanism to process the submitted updated snapshots and invoke the VP framework with the relevant input data. In particular, it requires tracking the code change identifiers, e.g., from the git commit hashes if the version control engine 145 is GIT, and then using the classification results to select a subset of updated snapshots for further comprehensive security review.

FIG. 3 shows an example algorithm by the training system 150 of FIG. 1 to train a classifier model for the source code management platform 100 to use. The classifier model can be any one of the plurality of classifier models 120-1-120-N implemented in the source code management platform 100.

The training data generation engine 160 of the training system 150 generates the training dataset 170 by implementing a training data generation process based on one or more security databases which are accessible by the training data generation engine 160. Examples of security databases include the common vulnerabilities and exposures (CV E) database maintained by MITRE and the national vulnerability database (NV D) maintained by the US government's National Institute of Science and Technology.

The training dataset 170 includes a plurality of training inputs. Each training input includes features associated a source code snippet that represents a source code change. Each training input is associated with a target output that represents a corresponding ground truth category of the source code snippet included in the training input. In some implementations, the possible ground truth categories include a vulnerability fixing change (VfC) category, a vulnerability inducing change (ViC) category, and a likely normal change (LNC) category.

The training data generation process implemented by the training data generation engine 160 involves four stages: (1) selecting cybersecurity vulnerabilities (CVEs) in a security database, (2) associating each cybersecurity vulnerability (CVE) with its corresponding fixes, i.e., VfCs, (3) locating of ViC(s) for each VfC, and (4) extracting features associated with the ViCs and VfCs.

The CVEs, LNCs, VfCs, and ViCs discussed with reference to FIG. 3 can each be represented by a source code snippet that includes one or more lines of source code written in any programming language, which collectively form an expression, statement, method signature, method body, and the like.

At stage (1), a list of cybersecurity vulnerabilities (CVEs) is selected from the security database. For example, a list of publicly disclosed software cybersecurity vulnerabilities can be selected. The list can include known software weaknesses. A software weakness is an error that can lead to a software vulnerability.

At stage (2), for each of the selected cybersecurity vulnerability, the associated V fC(s) are located. Stage (2) begins with identifying all the relevant issue (bug) report(s) linked from a given cybersecurity vulnerability issue. Bug reports offer insights into the vulnerability fixing process (e.g., discussions between developers and/or reviewers while reproducing or fixing them).

To that end, the training data generation engine 160 takes a list of issue (bug) IDs as input, scans the content of those issue (bug) reports, and returns any posted change IDs. Because code changes can be propagated to other branches, a single change can exist across multiple branches. At this stage, the training data generation engine 160 does not yet differentiate between original changes and propagated changes, gathering the change IDs (i.e., Gerrit IDs when the code review service is Gerrit) of all relevant changes.

In cases where relevant Gerrit changes or commits (e.g., URLs) linked to the VfCs are available, the training data generation engine 160 extracts the specific VfC IDs and commit hashes from the Gerrit IDs. In some cases, commits sharing the same change ID indicate propagation from the original change.

At stage (3), the vulnerability inducing changes (ViCs) for each vulnerability fixing change (VfC) is located. Having performed stage (1) to identify the cybersecurity vulnerabilities and performed stage (2) to identify the associated VfCs, the training data generation engine 160 automatically finds ViCs from each VfC based on executing an algorithm shown below in TABLE 1 on the commit history of a code repository, e.g., the GIT commit history. The commit history shows the historical commits sent to the code repository. Each historical commit includes an updated snapshot of a source code file stored in the code repository for the software project.

TABLE 1
A SIMPLIFIED ALGORITHM TO FIND
VICS FROM VFCS (IN PYTHON)

| | |
|---|---|
| 01: | def Find_ViCs_from_CVEs(CVEs): |
| 02: | ViCs = { } |
| 03: | for each CVE in CVEs: |
| 04: | VfCs = Find_VfCs_from_CVE(CVE) |
| 05: | ViCs.update(Find_ViCs_from_VfCs(VfCs)) |
| 06: | return ViCs |
| 07: | |
| 08: | def Find_ViCs_from_VfCs(VfCs): |
| 09: | ViCs_dict = { } |
| 10: | for each VfC in VfCs: |
| 11: | ViCs = set( ) |
| 12: | for each modified_file in VfC.files: |
| 13: | for each modified_line in modified_file.lines: |
| 14: | if IsEmpty(modified_line): |
| 15: | continue |
| 16: | if modified_line.type is ‘delete’: |
| 17: | ViC.add(code change that added or |
| 18: | last modified modified_line) |
| 20: | else: # otherwise, it's ‘add’. |
| 21: | pass |
| 22: | # Skips to group consecutively added lines |
| 23: | ViCs_dict[VfC.id] = ViCs |
| 24: | return ViCs_dict |

As shown in lines 12-23, the training data generation engine 160 first identifies all the modified lines (i.e., additions and deletions), e.g., by using the GIT show command, and subsequently parsing its output data to locate the modified lines that represent a ViC. As shown in lines 10-11, this process repeats for each VfC. Thus, if multiple ViCs are identified for a single V fC, the training data generation engine 160 identifies them all based on executing this algorithm.

At stage (4), for each ViC or VfC, a feature extractor, e.g., the feature extractor 110 of FIG. 1, is used to extract features associated with the ViC or VfC. Examples of the features that can be extracted are discussed above with reference to FIG. 1.

Thus, by implementing the training data generation process, the training data generation engine 160 generates a first plurality of training inputs for inclusion in the training dataset 170. Each first training input includes features associated a source code snippet that represents a source code change. Each first training input is associated with a target output that represents a corresponding ground truth category of the source code snippet included in the first training input. The corresponding ground truth category is one of: a vulnerability inducing change (ViC) category or a vulnerability fixing change (VfC) category.

In some implementations, the training data generation engine 160 implements an additional training data generation process to generate a second plurality of training inputs for inclusion in the same training dataset 170 as the first plurality of training inputs. Each second training input includes features associated a source code snippet that represents a likely normal code change (LNC). Each second training input is associated with a target output that represents a corresponding ground truth category (a likely normal code change (LNC) category) of the source code snippet included in the second training input.

A likely normal code change can be a source code snippet that has not be identified as a ViC or VfC at the time when the training data generation process is performed. For example, the training data generation engine 160 can mine a code repository for source code snippets that are not identified as ViCs or VfCs.

Then, the training system 150 proceeds to train the classifier model on the training dataset to determine trained values of parameters of the classifier model using an iterative training process. The iterative training process optimizes the values of the parameters of the classifier model in an iterative manner by using a gradient-based and, when the classifier model is a neural network, a gradient-based with backpropagation, optimization technique based on optimizing some objective function.

For example, the objective function can be a classification loss function that, for each training input obtained from the training dataset 170, measures a difference between (i) a training output generated by the classifier model based on processing the features associated the source code snippet included in the training input and (ii) a target output that represents a corresponding ground truth category of the source code snippet included in the training input.

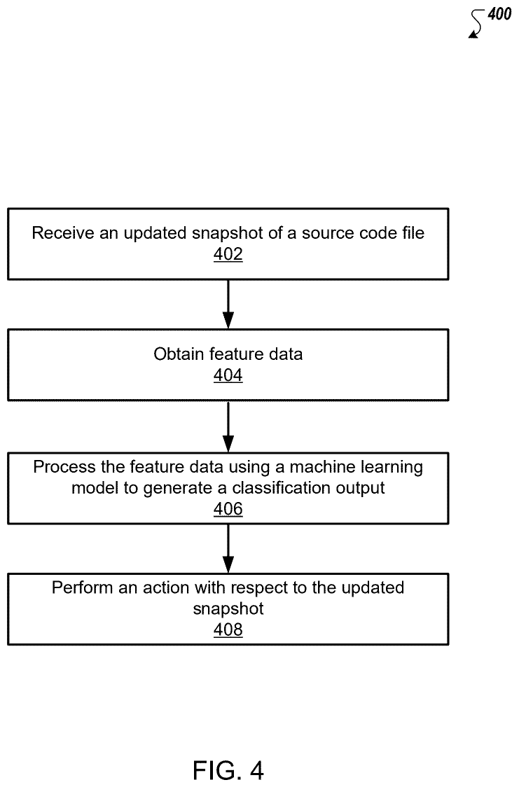

FIG. 4 is a flow diagram of an example process 400 performing an action with respect to an updated snapshot of a source code file. For convenience, the process 400 will be described as being performed by a system of one or more computers located in one or more locations. For example, a source code management system, e.g., the source code management system 100 depicted in FIG. 1, appropriately programmed in accordance with this specification, can perform the process 400.

The system receives an updated snapshot of a source code file (step 402). The updated snapshot includes a change to an existing snapshot of the source code file maintained at a code repository for a software project. For example, the system can receive the updated snapshot from a developer device that includes a coding tool.
The system obtains feature data associated with the updated snapshot (step 404). Examples of the feature data, as well as how the feature data can be obtained, are discussed above with reference to FIG. 1.

The system processes the feature data using each of one or more of a plurality of classifier models to generate a classification output that classifies the updated snapshot into one of a plurality of categories (step 406). Each of the plurality of classifier models can be configured as any of a variety of machine learning models.

In some implementations, the plurality of categories include: a vulnerability inducing change (ViC) category, a vulnerability fixing change (V fC) category, and a likely normal change (LNC) category. Alternatively, in some other implementations, the plurality of categories include: a likely vulnerable change category and a likely normal change category.

In some implementations, only one of the plurality of classifier models will be used to process the feature data to generate the classification output. For example, the system can randomly select a classifier model from the plurality of classifier, or select a classifier model based on the availabilities of the classifier models. As another example, the system can select a classifier model based on the features that are available, e.g., select a classifier model that has an input feature dimension that matches the number of the features associated with the updated snapshot.

In some implementations, two or more of the plurality of classifier models will be used to process the feature data to generate the classification output. In these implementations, the classification output can be a combination of the respective classification outputs generated by the two or more of the plurality of classifier models based on processing the feature data.

For example, the classification output can be a combined output that is generated based on combining the respective classification outputs using logical operators such as AND and OR. As another example, the classification output can be a weighted or unweighted average of (the probability scores included in) the respective classification outputs. As another example, the classification output can be a majority voting output. A majority voting output counts the votes of the classifier models and outputs the final classification output as the category with the majority of votes.

The system performs, based on the classification output, one or more actions with respect to the updated snapshot (step 408). The actions can include any action(s) automatically determined by the system based on the classification output.

For example, when the updated snapshot is classified by the classification output into a vulnerability fixing change (V fC) category snapshot or a likely normal change (LNC) category, the system can proceed to incorporate the updated snapshot into the software project. In some implementations, the system bypasses any security review of the updated snapshot prior to incorporating the updated snapshot into the software project.

As another example, when the updated snapshot is classified by the classification output into a vulnerability inducing change (ViC) category or a likely vulnerable change category, the system can block the updated snapshot from being incorporated into the software project. In some implementations, the system generates a notification that alerts the developer of the updated snapshot and existing reviewers to the potential presence of security vulnerabilities. In some implementations, the system requests additional security review of the updated snapshot, e.g., by security domain experts, while the updated snapshot remains blocked from being incorporated into the software project.

As another example, when the updated snapshot is classified by the classification output into a vulnerability inducing change (ViC) category or a likely vulnerable change category, the system can generate a repair snapshot that alleviates, e.g., fixes or repairs, the cybersecurity vulnerability in the updated snapshot. In some implementations, the system can do this by generating a prompt that includes (i) the updated snapshot of the source code file, (ii) a set of one or more debugging instructions that is represented as text in some natural language, and, optionally, (iii) the existing snapshot of the source code file, and causing a generative neural network to generate, as output, the repair snapshot based on processing the prompt.

Examples of the generative neural network include those described in Li, Y ujia, et al. Competition-level code generation with alphacode. Science 378.6624 (2022): 1092-1097. Gemini Team, et al., Gemini: a family of highly capable multimodal models. arXiv preprint arXiv: 2312.11805 (2023); and Gemini. Team, P, et al., Gemini 1.5: Unlocking multimodal understanding across millions of tokens of context. arXiv preprint arXiv: 2403.05530 (2024).

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a JAX framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
receiving an updated snapshot of a source code file that comprises a change to an existing snapshot of the source code file maintained at a code repository for a software project;
obtaining feature data that comprises at least one of:
(1) one or more code review features that characterize interactions between (a) a developer of the updated snapshot and (b) one or more reviewers of the updated snapshot;
(2) one or more process tracking features that characterize historical changes to the source code file; or
(3) one or more text mining features that characterize semantic similarities between (a) source code elements extracted by parsing the updated snapshot and (b) a predetermined set of source code elements;
processing the feature data using a machine learning model to generate a classification output that classifies the updated snapshot into one of a plurality of categories; and
performing, based on the classification output, an action with respect to the updated snapshot.

2. The method of claim 1, wherein the one or more code review features comprise at least one of:
(1) a feature that measures a length of time elapsed between an initial creation of the updated snapshot and a final submission of the updated snapshot;
(2) a feature that indicates a day of week when the updated snapshot is submitted;
(3) a feature that indicates an hour of day when the updated snapshot is submitted; or
(4) a feature that indicates how the updated snapshot is approved prior being submitted.

3. The method of claim 1, wherein the one or more process tracking features comprise at least one of:
(1) a feature that measures a change in a volume of the source code file between a current time period and a previous time period;
(2) a feature that measures a change in a number of snapshots of a particular category that have been submitted between the current time period and the previous time period; or
(3) a feature that measures a change in a number of snapshots of a particular category that have been incorporated into the software project between the current time period and the previous time period.

4. The method of claim 1, wherein the predetermined set of source code elements comprise one or more of:
arithmetic operators, comparison operators, conditional operators, loop operators, assignment operators, logical operators, or memory access operators.

5. The method of claim 1, wherein the one or more text mining features comprise, for each predetermined set of source code elements:
a feature that represents a ratio between (i) a number of source code elements in the predetermined set that have been extracted from the updated snapshot and (ii) a total number of source code elements in all of the predetermined sets of source code elements.

6. The method of claim 1, wherein processing the feature data using the machine learning model to generate the classification output comprises:
selecting the machine learning model from a plurality of machine learning models that comprise two or more of: machine learning model is one of: a decision tree model, a random forest model, a support vector machine model, a logistic regression mode, or a naïve Bayes model.

7. The method of claim 1, wherein the plurality of categories comprise:
(1) a vulnerability inducing snapshot that adds a new vulnerability to the existing snapshot;
(2) a vulnerability fixing snapshot that fixes an existing vulnerability of the existing snapshot; and
(3) a likely normal snapshot that is unlikely to add a new vulnerability to the existing snapshot.

8. The method of claim 1, wherein the feature data further comprises profile features that characterize the developer or the one or more reviewers of the updated snapshot, the profile features comprising one or more of:
(1) a feature that characterizes a trustworthiness of the developer; or
(2) a feature that characterizes a trustworthiness of each of the or more reviewers.

9. The method of claim 1, wherein the feature data further comprises change complexity features that characterize a complexity of the change included in the updated snapshot, the change complexity features comprising at least one of:
(1) a feature that defines a total number of lines of source code added by the change to the existing snapshot of the source code file; or
(2) a feature that defines a total number of lines of source code deleted by the change from the existing snapshot of the source code file.

10. The method of claim 1, wherein the feature data further comprises patch set complexity features that characterize a patch set complexity of the updated snapshot, the patch set complexity features comprising at least one of:
(1) a feature that defines a total number of patch sets generated for the updated snapshot, each patch set generated as a result of a reviewing process;
(2) a feature that defines a total number of line source code that are being added to the updated snapshot by the patch sets generated for the updated snapshot;
(3) a feature that defines a total number of line source code that are being deleted from the updated snapshot by the patch sets generated for the updated snapshot; or
(4) a feature that represents an average volume of edits to the updated snapshot across the patch sets.

11. The method of claim 1, wherein the feature data further comprises vulnerability history features that characterize vulnerability history of the source code file for the software project, wherein the vulnerability history features comprise a vulnerability history score of each of a plurality of source code files maintained at the code repository for the software project, and wherein the vulnerability history score of each of the plurality of source code files is dependent on number of snapshots of the source code file that have predetermined categories.

12. The method of claim 1, wherein performing, based on the classification output, the action with respect to the updated snapshot:
when the updated snapshot is classified as a vulnerability fixing snapshot, incorporating the updated snapshot into the software project.

13. The method of claim 12, wherein incorporating the updated snapshot into the software project comprises:
bypassing security review of the updated snapshot prior to incorporating the updated snapshot into the software project.

14. The method of claim 1, wherein performing, based on the classification output, the action with respect to the updated snapshot:
when the updated snapshot is classified as a vulnerability inducing snapshot, blocking the updated snapshot from being incorporated into the software project.

15. The method of claim 14, wherein blocking the updated snapshot from being incorporated into the software project comprises:
requesting additional security review of the updated snapshot.

16. The method of claim 1, further comprising:
generating a training dataset based on a list of source code changes and, for each source code change, a corresponding ground truth category, wherein the training dataset comprises a plurality of training inputs, each training input comprising features associated with each source code change in the list; and
training the machine learning model on the training dataset to determine trained values of parameters of the machine learning model.

17. A system comprising one or more computers and one or more storage devices storing instructions that when executed by the one or more computers cause the one more computers to perform operations comprising:
receiving an updated snapshot of a source code file that comprises a change to an existing snapshot of the source code file maintained at a code repository for a software project;
obtaining feature data that comprises at least one of:
(1) one or more code review features that characterize interactions between (a) a developer of the updated snapshot and (b) one or more reviewers of the updated snapshot;
(2) one or more process tracking features that characterize historical changes to the source code file; or
(3) one or more text mining features that characterize semantic similarities between (a) source code elements extracted by parsing the updated snapshot and (b) a predetermined set of source code elements;
processing the feature data using a machine learning model to generate a classification output that classifies the updated snapshot into one of a plurality of categories; and
performing, based on the classification output, an action with respect to the updated snapshot.

18. The system of claim 17, wherein performing, based on the classification output, the action with respect to the updated snapshot:
when the updated snapshot is classified as a vulnerability fixing snapshot, incorporating the updated snapshot into the software project.

19. The system of claim 17, wherein performing, based on the classification output, the action with respect to the updated snapshot:
when the updated snapshot is classified as a vulnerability inducing snapshot, blocking the updated snapshot from being incorporated into the software project.

20. One or more non-transitory computer storage media storing instructions that when executed by one or more computers cause the one more computers to perform operations comprising:
receiving an updated snapshot of a source code file that comprises a change to an existing snapshot of the source code file maintained at a code repository for a software project;
obtaining feature data that comprises at least one of:
(1) one or more code review features that characterize interactions between (a) a developer of the updated snapshot and (b) one or more reviewers of the updated snapshot;
(2) one or more process tracking features that characterize historical changes to the source code file; or
(3) one or more text mining features that characterize semantic similarities between (a) source code elements extracted by parsing the updated snapshot and (b) a predetermined set of source code elements;
processing the feature data using a machine learning model to generate a classification output that classifies the updated snapshot into one of a plurality of categories; and
performing, based on the classification output, an action with respect to the updated snapshot.
